(19) United States
(12) Patent Application Publication
(10) Pub. No.: US 2023/0174697 A1
(43) Pub. Date: Jun. 8, 2023

(54) HYDROGELS, METHODS OF FABRICATION AND USES THEREOF

(71) Applicant: Agency For Science, Technology And Research, Singapore (SG)

(72) Inventor: Weijie Cyrus BEH, Nanos (SG)

(21) Appl. No.: 17/995,612

(22) PCT Filed: Mar. 31, 2021
(86) PCT No.: PCT/SG2021/050179

§ 371 Date: Oct. 6, 2022

(30) Foreign Application Priority Data
Apr. 6, 2020 (SG) 10202003161Q

(51) Int. Cl. C08F 220/18; C08F 2/46; C08F 2/28; C08F 2/44; C08F 222/38

(52) U.S. Cl. CPC C08F 220/1802; C08F 2/28; C08F 2/44; C08F 2/46; C08F 222/385

(57) ABSTRACT

The present invention relates, in general terms, to hydrogels and their uses thereof. The hydrogels demonstrate toughness; i.e. the ability to absorb energy and plastically deform without fracturing. The present invention also relates to methods of fabricating hydrogels. In particular, the method of fabricating a tough hydrogel comprises polymerising a plurality of charged monomers in the presence of multivalent ions in order to form an ion impregnated hydrogel and exposing the ion impregnated hydrogel to heat in order to form the tough hydrogel.

### TECHNICAL FIELD

The present invention relates, in general terms, to hydrogels and their uses thereof. The present invention also relates to methods of fabricating hydrogels.

### BACKGROUND

Hydrogels are unique materials that have found a wide variety of uses, including in wound dressings, as superabsorbent polymer beads in applications such as diapers, and also as substrates for bioengineered tissues. This is in large part because of their compatibility with biological systems, which allows them to interface with biological systems. However, traditionally, hydrogels are very stiff and/or brittle, or soft and fragile (FIG. 1). By manipulating the composition of the hydrogel, researchers have more recently started exploring stretchable hydrogels.

Traditionally, a tough gel can be formed by combining a stretchy hydrogel (which contains low covalent crosslinks), with noncovalent and reversible physical crosslinks, including ionic and hydrophobic interactions. To accomplish this dually-crosslinked gel, it is common to blend a polymer capable for forming such reversible bond (e.g. a polyanion such as alginate), with monomers that polymerize into a hydrogel network. In this way, the two components become intertwined, and inducing the gelation of the first polymer can then complete the formation of the dually-crosslinked hydrogel.

When stretched, such hydrogels undergo deformation like normal materials. However, in addition to the elastic deformation of the covalent network, the external force also breaks the reversible bonds, resulting in energy absorption. This dissipation of energy is what makes these dually-crosslinked gels tough -that is, they can undergo deformation without permanently breaking. Accordingly, they can be made relatively stiff, without being brittle. In fact, since damage to the covalent network is what causes hydrogels to break apart easily, these tough gels by breaking and reforming the reversible bonds can routinely be stretched to more than 100% its original length without sustaining irreversible damage.

Hydrogels having a stiffness in a range from hundreds of pascals to megapascals can be advantageous. For example, applications that require soft but tough materials include wearables, implantables, and prosthetics. However, existing methods for making these tough materials often involve diffusion of ions into polymer networks, and which is impractical for thick structures. Other approaches, for example, by casting, or by heating slowly in a humidified chamber, require long maturation times and is accordingly of limited utility.

3D printable tough gels have potential uses as interfacing materials for prosthetics. They can also be used for making organ models for simulation of surgical techniques, solving the problem of insufficient cadavers, as well as providing surgeons with materials to practice surgical approaches before an actual procedure. However, several challenges remain to be addressed.

### Gelation Mechanism

3D printing requires the selective formation of solid or gels in particular spatial location, and not others. Typically, this is achieved by thermal means (melting a material, extruding it in a desired location where it cools and solidifies), or by photocrosslinking (using patterned light to initiate polymerization at specific locations). While thermal gels exist (e.g. agarose and gelatin), they are not particularly stretchy. Photopolymerization is thus the commonly used method. This in turn is limiting as it precludes any system that absorbs or scatters the excitation light source significantly, such as casein.

### Print Speed

The low crosslinking density in stretchy hydrogels typically means that complete gelation takes a relatively long time. Furthermore, the non-covalent bonds often take many hours to mature and stabilize after the initial formation of the covalent network. As such tough gels have typically been prepared using casting methods. In order to achieve 3D printing of tough gels, the crosslinking step that forms the initial covalent gel ought to take place at speeds comparable to the 3D printer’s operation. This translates to complete crosslinking within minutes, to make 3D printing of the material practicable.

### Rheological Properties

In many cases the non-covalent bond requires the presence of a second polymeric network, which can be very viscous and thus difficult to work with. For example, alginate, which is often used to create the tough gels in the presence of calcium, can be extremely viscous, barely flowing even when inverted. One also has to consider the compatibility of the components - the monomer in the covalent network may not be miscible with the polymer meant to confer non-covalent bonds, such as acrylic acid and alginate.

Accordingly, traditional methods of making tough hydrogels cannot be readily translated to a 3D printing platform.

It would be desirable to overcome or ameliorate at least one of the above-described problems, or at least to provide a useful alternative.

### SUMMARY

The present invention is predicated on the understanding that incorporating mechanisms to dissipate fracture energy into the network is critical to design a tough hydrogel. In this regard, the inventors have found that dual-crosslinked hydrogels containing both covalent and non-covalent bonds in the network can be advantageous. The non-covalent bonds can be provided by ionic interactions such that the weaker non-covalent bonds break to dissipate energy as sacrificial bonds, while the covalent bonds are preserved. In particular, the inventors have found that polymerization of charged monomers in the presence of multivalent ions, and subsequently rearranging the charged polymer-multivalent ion interactions, can advantageously provide this non-covalent dissipative bonds by in-situ formation, resulting in tough hydrogels.

The present invention provides a method of fabricating a tough hydrogel, comprising:
(a) polymerising a plurality of charged monomers in the presence of a plurality of multivalent ions under predetermined conditions in order to form an ion impregnated hydrogel;
(b) exposing the ion impregnated hydrogel to heat;
(c) cooling the ion impregnated hydrogel of step (b); and
(d) optionally repeating step (b) and/or (c) at least one further time in order to form the tough hydrogel;
wherein a valency of the multivalent ion is at least 2.

The monomers can be polymerized and covalently crosslinked using, for example, free-radical polymerization with the charged monomeric units neutralised by the multivalent ions. The ionic interactions between the multivalent ions and the ionic polymer (made up of charged monomers that have now been polymerized) can be disrupted with heat (for example via microwave) and rearranged upon cooling, resulting in a second set of crosslinks in the same gel (this second set of crosslink is non-covalent). Advantageously, the method allows the long polymer chains and multivalent ions to rearrange on cooling, permitting the re-formation of residue/ion attraction, where a single multivalent ion can interact with multiple polymer chains. The formation of charge-charge interaction of a single multivalent ion with multiple chains allows the hydrogel to attain tough characteristics, since, upon mechanical stress, the physical interactions between the ions and polymer chains can be broken as chains move relative to one another, resulting in absorption of energy from external force. The ionic interactions can be reformed when the mechanical stress is removed.

In some embodiments, the plurality of charged monomer is a charged vinyl monomer.

In some embodiments, the plurality of charged monomer is a salt form of a plurality of monomer, the plurality of monomer is selected from acrylic acid, acrylamide, sulfopropyl acrylate, 2-hydroxyethyl methacrylate or a combination thereof.

In some embodiments, the plurality of charged monomer is provided at a concentration of about 5 wt% to about 50 wt%.

In some embodiments, the step of polymerising (step (a)) further comprises a cross linking agent.

In some embodiments, the cross linking agent is N,N′-methylenebisacrylamide.

In some embodiments, the plurality of multivalent ions is a plurality of multivalent cations.

In some embodiments, the plurality of multivalent cations is selected from Al³⁺ and Fe³⁺.

In some embodiments, the plurality of multivalent ions is provided at a concentration of about 10 mM to about 2 M.

In some embodiments, the exposure step (step (b)) crosslinks the ion impregnated hydrogel (from step (a)) via ionic interactions.

This advantageously forms the secondary crosslinks by ionic interactions.

In some embodiments, the ion impregnated hydrogel (from step (a)) is exposed to heat at a temperature of about 40° C. to about 100° C.

In some embodiments, the ion impregnated hydrogel (from step (a)) is heated by exposing the ion impregnated hydrogel to microwave radiation for at least 15 sec.

In some embodiments, step (b) and/or step (c) is repeated 2 to 10 times. In other embodiments, the ion impregnated hydrogel (from step (a)) is exposed to at least 2 cycles of microwave radiation. In some embodiments, the hydrogel is rested for at least about 10 sec.

In some embodiments, the toughness of the hydrogel is increased by at least about 100%.

The present invention also provides a hydrogel as fabricated by the method as disclosed herein.

The present invention also provides a hydrogel, comprising:
(a) a plurality of charged polymers, the plurality of charged polymers is covalently crosslinked and comprises a plurality of charged moiety; and
(b) a plurality of multivalent ions impregnated within the hydrogel in order to form ionic crosslinks between the plurality of charged polymers;
wherein a valency of the plurality of multivalent ions is at least 2.

In some embodiments, the plurality of charged polymers is a salt form of a plurality of polymers, the polymers selected from polyacrylic acid, polyacrylamide, polysulfopropyl acrylate, poly(2-hydroxyethyl) methacrylate or a combination thereof.

In some embodiments, the hydrogel has a at least 80% recovery of mechanical strength after a resting period of about 30 min.

### BRIEF DESCRIPTION OF THE DRAWINGS

Embodiments of the present invention will now be described, by way of non-limiting example, with reference to the drawings in which:

FIG. 1 illustrates a schematic of the parameters used to make various types of gels;

FIG. 2 illustrates a schematic of stretching dually-crosslinked gel of the prior art;

FIG. 3 illustrates a stress-strain plot of a prior art hydrogel;

FIG. 4 shows a schematic of forming an ion impregnated hydrogel of the present invention;

FIG. 5 shows a schematic of microwaving the hydrogel;

FIG. 6 shows a plot of energy dissipation from exemplary hydrogels after exposure to different number of cycles of 15-second microwave exposure compared to comparator;

FIG. 7 shows a plot of the effect of recovery time on energy absorption in exemplary hydrogels; and

FIG. 8 plots a hydrogel of the present invention compared to a comparator.

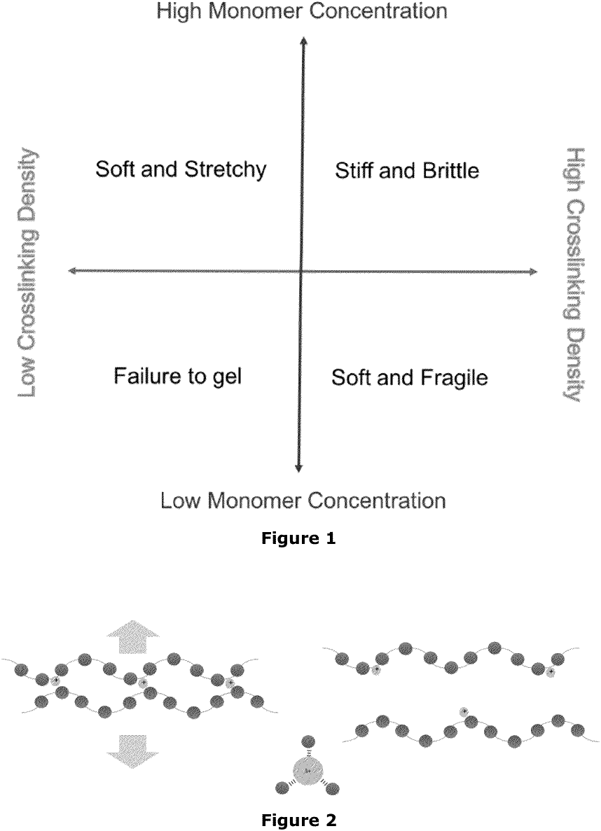

### DETAILED DESCRIPTION

Hydrogels can be defined as two or multi-component systems comprising of 3D network of polymer chains and an aqueous medium (or biological fluids) that fills the spaces between the macromolecules. The terms ‘hydrogel’, ‘gel’ and the like are used interchangeably herein to refer to a material which comprises a network of polymer chains cross-linked in some fashion to develop an elastic property. Polymer can comprise of naturally occurring molecules such as peptides or chemically synthesized chains. The cross-linking can be due to chemical covalent linkages or physical interactions such as entanglement, electrostatics and the likes. Hydrogels can be in a viscous state, semi-solid state or solid state. The hydrogel as used herein refers to a hydrated or swollen form, which may comprise of from 0.06% w/v or more of hydrogel forming material, and from 99.04% w/v or less of an aqueous medium. Generally, hydrogels are at least 80% by weight of an aqueous solution.

The term ‘aqueous medium’ used herein refers to a water based solvent or solvent system, and which comprises of mainly water. Such solvents can be either polar or non-polar, and/or either protic or aprotic. Solvent systems refer to combinations of solvents which resulting in a final single phase. Both ‘solvents’ and ‘solvent systems’ can include, and is not limited to, pentane, cyclopentane, hexane, cyclohexane, benzene, toluene, dioxane, chloroform, diethylether, dichloromethane, tetrahydrofuran, ethyl acetate, acetone, dimethylformamide, acetonitrile, dimethyl sulfoxide, nitromethane, propylene carbonate, formic acid, butanol, isopropanol, propanol, ethanol, methanol, acetic acid, ethylene glycol, diethylene glycol or water. Water based solvent or solvent systems can also include dissolved ions, salts and molecules such as amino acids, proteins, sugars and phospholipids. Such salts may be, but not limited to, sodium chloride, potassium chloride, ammonium acetate, magnesium acetate, magnesium chloride, magnesium sulfate, potassium acetate, potassium chloride, sodium acetate, sodium citrate, zinc chloride, HEPES sodium, calcium chloride, ferric nitrate, sodium bicarbonate, potassium phosphate and sodium phosphate. As such, biological fluids, physiological solutions and culture medium also falls within this definition.

Other materials may be added to the hydrogel which is not involved intrinsically in forming the hydrogel as a hydrogel forming material. Such molecules may be pharmaceutically acceptable excipients, adjuvants, biologically active agent and/or drug compounds. For example, a peptide or molecule may provide additional functional properties such as, but not limited to, anti-microbial, antibacterial, drug delivery, blood clotting, wound healing, and antiseptics.

Typically, the hydrogel is considered formed when the storage modulus (G′) is greater than the loss modulus (G″). Alternatively, the Young’s modulus can also be used. Young’s modulus is a mechanical property that measures the stiffness of a solid material. It defines the relationship between stress and strain in a material in the linear elasticity regime of a uniaxial deformation. Such parameters can be obtained, for example, by using a rheometer.

Toughness is the ability of a material to absorb energy and plastically deform without fracturing; i.e. the amount of energy per unit volume that a material can absorb before rupturing. Toughness of a hydrogel can be characterized by the energy dissipated in the gel during stretching, which is measured using the area bounded by the hysteresis loop. Toughness can be described as the area under a Stress/Strain curve, and has the units of J/m³. The toughness of a hydrogel can be attributed to the synergy of two mechanisms: crack bridging by the network of covalent crosslinks, and hysteresis by unzipping the network of ionic crosslinks. Tough hydrogels are networks of polymers containing absorbed water that can absorb a large amounts of energy, such as mechanical energy, before failure. In the present disclosure, the toughness can be controlled by the degree of non-covalent (for example ionic) crosslinks.

Stiffness is the extent to which an object resists deformation in response to an applied force. A material that is stiff can withstand high loads without elastic deformation; i.e. its ability to return to its original shape or form after an applied load is removed. The stiffness of a material can be in part characterised by the elastic modulus of a material. Elastic modulus is a property of the constituent material; stiffness is a property of a structure or component of a structure, and hence it is dependent upon various physical dimensions that describe that component. That is, the modulus is an intensive property of the material; stiffness, on the other hand, is an extensive property of the solid body that can be further dependent on the material and its shape and boundary conditions. In the present disclosure, the stiffness can be controlled by the number of covalent bonds (for example length of the polymer chains and crosslinker concentration). A distinction should be made with double network (DN) gels. DN gels are characterized by a special network structure consisting of two types of polymer components with opposite physical natures: the minor component is abundantly cross-linked polyelectrolytes (rigid skeleton) and the major component comprises of poorly cross-linked neutral polymers (ductile substance). The former and the latter components are referred to as the first network and the second network, respectively, since the synthesis should be done in this order to realize high mechanical strength. DN gels are not within the scope of the present invention.

The present invention provides a tough hydrogel by forming noncovalent interactions using the covalent hydrogel network itself. The present invention also provides a method of forming the tough hydrogel, and a method of increasing a toughness of a hydrogel. In particular, a charged monomer that can (rapidly) crosslink with an ion of opposite charge can be used to form an initial hydrogel, and which attains its desired properties by means of microwave treatment. This treatment rearranges the polymer chains and/or the multivalent ions in the gel, allowing breakage and reformation of bonds between the ion and the residues in the polymer, thus permitting the attainment of a dissipative network as well as an elastic one.

As a prior art example, a gel was formed using a 3D printable formulation of acrylic acid, bis-acrylamide, and LAP photoinitiator. The exact formulation can be tailored to the requirements of the user. This negatively-charged hydrogel can then be soaked in a solution of multivalent cations to yield an ion impregnated gel having a plurality of multivalent ions incorporated within (FIG. 2).

FIG. 2 illustrates a schematic of stretching dually-crosslinked gel of the prior art. Soaking introduces trivalent cations into the negatively-charged polymer chains. These ionic interactions form across polymer chains, which can be broken when loaded. The breaking of these ionic bonds absorbs energy, and can confer toughness to the hydrogels.

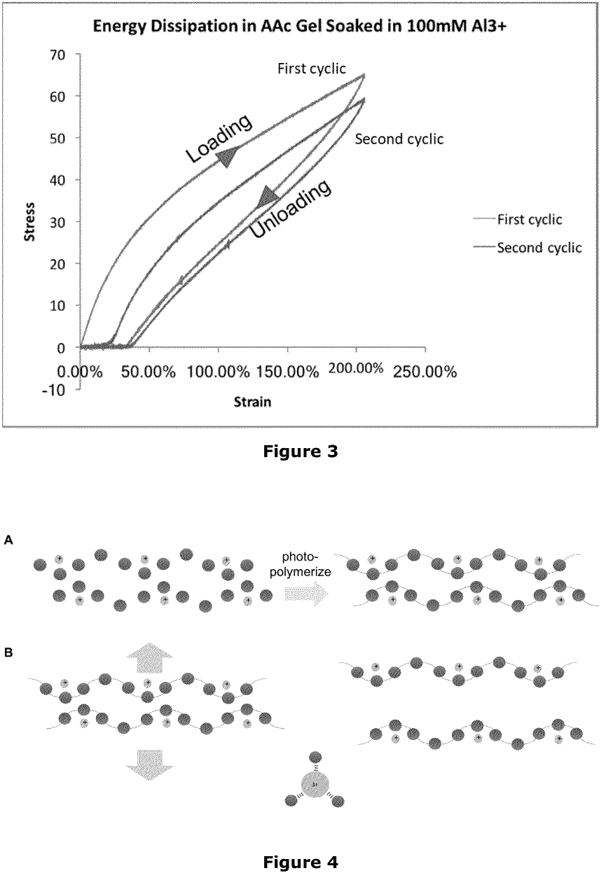

FIG. 3 shows the loading and unloading of a 1 mm-thick tough gel sample prepared by photopolymerization and soaking in 100 mM Al³⁺.

However, as the prior art method depends on diffusion of ions into the gel via a concentration gradient, the process is diffusion limited and thus not effective for thick gels.

The diffusion method works well for thin structures having a thickness of less than about 1 cm. It was found that as the hydrogels become thicker, the diffusion of ions become increasingly rate limiting. Accordingly, a longer duration may be required. Soaking also requires careful control of osmolarity, since these soft hydrogels have a tendency to swell.

Additionally, as the exterior region of the gel gets increasingly crosslinked, it acts a barrier for the inner region of the gel to be crosslinked.

It was found that polymerising monomers in situ in the presence of the plurality of multivalent ions was advantageous as it can overcome at least the limitations of diffusion.

Accordingly, the present invention provides a method of fabricating a tough hydrogel, comprising:
(a) polymerising a plurality of charged monomers in the presence of a plurality of multivalent ions under predetermined conditions in order to form an ion impregnated hydrogel;
(b) exposing the ion impregnated hydrogel to heat; and
(c) optionally repeating step (b) at least one further time in order to form the tough hydrogel;
wherein a valency of the multivalent ion is at least 2.

In particular, the method of fabricating a tough hydrogel comprises:
(a) polymerising a plurality of charged monomers in the presence of a plurality of multivalent ions under predetermined conditions in order to form an ion impregnated hydrogel;
(b) exposing the ion impregnated hydrogel to heat;
(c) cooling the ion impregnated hydrogel of step (b); and
(d) optionally repeating step (b) and/or (c) at least one further time in order to form the tough hydrogel;
wherein a valency of the multivalent ion is at least 2.

As an example, a trivalent cation was introduced into the acrylic acid hydrogel precursor (monomer) before polymerization. In order to be compatible with most photocrosslinking wavelengths, aluminium (Al³⁺) was chosen. Photocrosslinking the gel rapidly creates a soft, stretchy hydrogel, with Al³⁺ trapped within the hydrogel. However, since the monomers associated with the Al³⁺ are likely to be incorporated into a single chain (due purely to proximity), they will not dissipate significant amounts of energy when loaded (FIG. 4 and FIG. 6, 0X microwave samples).

FIG. 4 shows a schematic of monomers associated with a single multivalent cation tends to be incorporated into a single polymer chain (A). When loaded, the chains separate with minimal dissipation of energy (B).

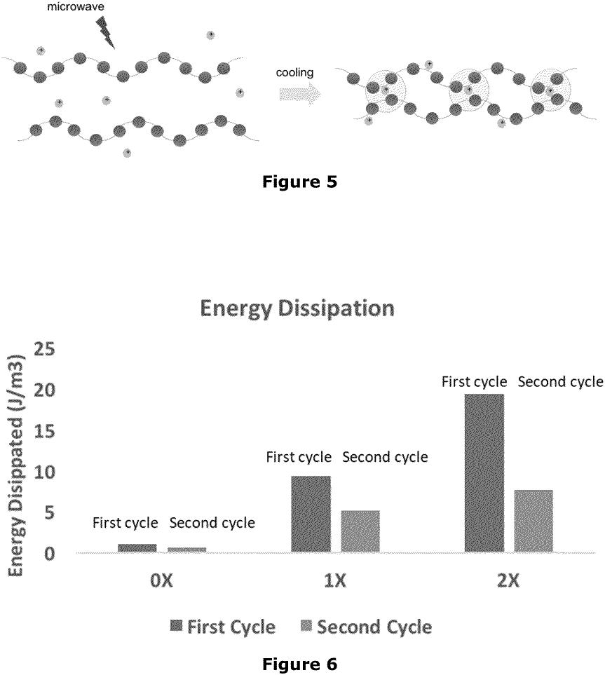

Next, the hydrogel is subject to heating by for example microwave (FIG. 5). This process allows the ionic interactions of the cation to the single polymer to be disrupted. On cooling, the ionic bonds re-form randomly, permitting the formation of inter-chain ionic crosslinks.

FIG. 5 shows that microwaving the hydrogel disrupts the intra-chain ionic interactions, which re-form randomly on cooling, resulting in increased inter-chain ionic bonds (right, circled). The rearrangement of the intra-chain ionic bonds into inter-chain ionic bonds imparts toughness to the hydrogel.

The rearrangement of the intra-chain ionic bonds can generally be accomplished using heating. It was further found that using microwave radiation as the heating source was particularly advantageous in that it allows for the quick and deeper penetration into the hydrogel structure, thereby accelerating this process. This can be useful in allowing very thick structures to reach equilibrium in a short time. This is akin to defrosting meat in a microwave, where short bursts of microwave can penetrate more deeply, and more quickly, without over-heating the surface (FIG. 6).

The plurality of charged monomers is polymerised in the plurality of multivalent ions by mixing the plurality of charged monomers in a solution comprising the plurality of multivalent ions. The solution can be an aqueous solution or medium.

In some embodiments, the plurality of multivalent ions is provided at a concentration of about 10 mM to about 2 M. In other embodiments, the concentration is about 10 mM to about 1.5 M, about 10 mM to about 1 M, about 10 mM to about 900 mM, about 10 mM to about 800 mM, about 10 mM to about 700 mM, about 10 mM to about 600 mM, about 10 mM to about 500 mM, about 50 mM to about 500 mM, about 50 mM to about 400 mM, about 50 mM to about 300 mM, about 50 mM to about 200 mM, or about 50 mM to about 150 mM. In some embodiments, the predetermined conditions is a multivalent ion concentration of about 100 mM.

Advantageously, it was found that the toughness of the hydrogel can be varied by controlling the concentration of multivalent ions provided in the resin. With an increase in multivalent ion concentration, the toughness can be increased. It was further found that the toughness appears to plateau off depending on the material used and at a certain concentration. For example, when the gel is polyacrylic acid, the toughness plateaus off when the concentration is more than 500 mM.

In some embodiments, the plurality of multivalent ions is a plurality of multivalent cations. The cations are able to form inter-chain ionic bonds with the negatively charged monomer units of the polymer.

In some embodiments, the plurality of multivalent cations is a plurality of divalent cations, trivalent cations, or a combination thereof. Examples of divalent cations are, but not limited to, Mg²⁺, Co²⁺, Ni²⁺, Cu²⁺, Zn²⁺, Ca²⁺, Ba²⁺, Pb²⁺, Fe²⁺, and Ag²⁺. Examples of trivalent cations are, but not limited to, Fe³⁺, Al³⁺, and Cr³⁺. In other embodiments, the multivalent cations is selected from Al³⁺ and Fe³⁺. In other embodiments, the multivalent cations is Al³+.

Advantageously, trivalent cations were found to be able to bridge multiple polymer backbone chains. It was found that trivalent cations are particularly advantageous as it provides a higher charged density compared to divalent cations. Accordingly, the ionic bonds that form can be stronger than that formed using divalent cations.

It was found that colourless salts can also be particularly advantageous as it does not affect the photocrosslinking of the monomer.

Without wanting to be bound by theory, it is believed that different anions will give different degrees of toughness as the presence of anions provides repulsion and/or neutralisation forces between the cations and the charged monomer units of the polymer. The monovalent anions will compete with the polyanion network in the gel, and reduce the charge interactions. This is commonly referred to as shielding. Towards this end, it was found that monovalent anions are particularly advantageous. Examples of monovalent anions are, but is not limited to, F^{—}, Cl^{—}, Br^{—}, I^{—}, and OH^{—}.

In some embodiments, the plurality of charged monomer is a charged vinyl monomer. A vinyl monomer has an ethylene functional group. A charged vinyl monomer is a vinyl monomer comprises a charged moiety. The charged moiety can for example be carboxyl, amino, phosphate, hydroxyl, sulfonate and sulfhydryl. In other embodiments, the plurality of charged monomer is an optionally substituted acrylate monomer. In other embodiments, the plurality of charged monomer is an acrylate monomer, a methacrylate monomer ethylacrylate monomer, or a combination thereof. Other charged monomers are expected to behave in a similar manner.

In some embodiments, the plurality of charged monomer is a salt form of a plurality of monomer, the plurality of monomer is selected from acrylic acid, acrylamide, sulfopropyl acrylate, 2-hydroxyethyl methacrylate or a combination thereof. In other embodiments, the plurality of charged monomer is a salt form of an optionally substituted acrylate monomer. In other embodiments, the plurality of charged monomer is a salt form of an acrylate monomer, a methacrylate monomer ethylacrylate monomer, or a combination thereof.

In some embodiments, the plurality of monomer is provided at a concentration of about 5 wt% to about 50 wt%. In other embodiments, the concentration is about 5 wt% to about 45 wt%, about 5 wt% to about 40 wt%, about 5 wt% to about 35 wt%, about 5 wt% to about 30 wt%, or about 10 wt% to about 30 wt%.

In some embodiments, the step of polymerising (step (a)) further comprises a cross linking agent.

In some embodiments, the cross linking agent is provided at a concentration of about 0.01 wt% to about 1 wt%. In other embodiments, the concentration is about 0.01 wt% to about 0.9 wt%, about 0.01 wt% to about 0.8 wt%, about 0.01 wt% to about 0.7 wt%, about 0.01 wt% to about 0.6 wt%, about 0.01 wt% to about 0.5 wt%, about 0.01 wt% to about 0.4 wt%, about 0.01 wt% to about 0.3 wt%, about 0.01 wt% to about 0.2 wt%, or about 0.01 wt% to about 0.1 wt%. In other embodiments, the concentration is about 0.01 wt%, about 0.02 wt%, about 0.03 wt%, about 0.04 wt%, about 0.05 wt%, about 0.06 wt%, about 0.07 wt%, about 0.08 wt%, about 0.09 wt%, or about 0.1 wt%.

In some embodiments, the cross linking agent is a bifunctional cross linking agent. In other embodiments, the cross linking agent is a trifunctional cross linking agent. In other embodiments, the cross linking agent is a multifunctional cross linking agent. In other embodiments, the cross linking agent is an optionally substituted acrylate cross linking agent. In other embodiments, the cross linking agent is an optionally substituted methacrylate cross linking agent. In other embodiments, the cross linking agent is selected from PEG diacrylate, triacrylate (such as trimethylolpropane triacrylate, pentaerythritol triacrylate, tris[2-(acryloyloxy)ethyl] isocyanurate, trimethylolpropane ethoxylate triacrylate, glycerol propoxylate (1PO/OH) triacrylate), or tetraacrylate (such as di(trimethylolpropane) tetraacrylate, pentaerythritol tetraacrylate). In other embodiments, the cross linking agent is N,N′-methylenebisacrylamide.

In some embodiments, plurality of charged monomers is polymerised by free radical polymerisation. In other embodiments, the plurality of charged monomers is polymerised by photocrosslinking.

For example, the hydrogel can be formed into structures using digital light processing (DLP). DLP is a 3D printing method that uses a projector. The projector flashes light onto the entire layer of resin at once, selectively solidifying the part using thousands of minuscule mirrors called DMDs (digital micromirror devices) that direct the projection of light. Other types of 3D printing methods such as stereolithography and LCD 3D printing can also be used.

In other embodiments, the polymerisation of a plurality of charged monomers in the presence of a plurality of multivalent ions is for at least about 1 h. In other embodiments, the time is at least about 10 min, about 20 min, about 30 min, about 40 min, about 50 min, about 1.5 h, about 2 h, or about 4 h.

In some embodiments, the exposure step (step (b)) crosslinks the ion impregnated hydrogel (from step (a)) via ionic interactions.

In some embodiments, the heat is provided by thermal conduction and/or microwave radiation. For example, heat can be provided to the hydrogel by submerging the hydrogel in a water bath, which is subsequently thermally heated or microwaved.

In some embodiments, the ion impregnated hydrogel (from step (a)) is exposed to heat for at least 15 sec. In other embodiments, the exposure is about 5 sec, about 7 sec, about 10 sec, about 15 sec, about 20 sec or about 30 sec. In other embodiments, the exposure is about 5 sec to about 30 sec, or about 5 sec to about 20 sec. In other embodiments, the exposure is at least about 1 min, about 2 min, about 3 min, about 4 min, about 5 min, about 10 min or about 20 min.

In some embodiments, the ion impregnated hydrogel (from step (a)) is heated by exposing the ion impregnated hydrogel to microwave radiation for at least 15 sec. In other embodiments, the exposure is about 5 sec, about 7 sec, about 10 sec, about 15 sec, about 20 sec or about 30 sec. In other embodiments, the exposure is about 5 sec to about 30 sec, or about 5 sec to about 20 sec.

The ion impregnated hydrogel is preferentially cooled after the exposure step. This allows the hydrogel to rest such that inter-chain ionic bonds can form. This can be performed by removing the hydrogel from the heating source or taking the hydrogel out from the water bath. In some embodiments, the hydrogel is rested or cooled for at least about 10 sec, about 20 sec, about 30 sec, about 40 sec, about 50 sec, about 1 min, about 5 min, about 10 min, about 20 min, about 30 min, or about 60 min.

In some embodiments, the exposure step and/or cooling step are repeated at least one further time. In some embodiments, the steps are each independently repeated 2 to 10 times. As shown in FIG. 6, when the exposure step is at least repeated for another time, the toughness of the hydrogel can be further increased by at least 100% relative to the toughness of the hydrogel with only one exposure. In other embodiments, the exposure step is repeated at least two times. In other embodiments, the exposure step is repeated at least three times, at least four times, at least five times or at least six times. In other embodiments, the cooling step is repeated at least two times. In other embodiments, the cooling step is repeated at least three times, at least four times, at least five times or at least six times. In other embodiments, the ion impregnated hydrogel (from step (a)) is exposed to at least 2 cycles of heating. In other embodiments, the initial gel (from step (a)) is exposed to at least 3 cycles, at least 4 cycles, at least 5 cycles or at least 6 cycles.

In between the cycles of exposure steps, at least a cooling step is present. In some embodiments, when the method comprises at least two exposure steps, the method further comprises a step (between the exposure steps) of resting or cooling the hydrogel. In this regard, the hydrogel is rested for some time before being radiated or heated again. This can be performed by removing the hydrogel from the heating source or taking the hydrogel out from the water bath. This resting step allows the hydrogel to cool, and provides sufficient time for the inter-chain ionic bonds to form. This also ensures that the gel has time to heat up more uniformly and not only at the surface (with expanding gas causing gel rupture) while the core of the gel remains unheated. This is particularly important for thick gels. It was found that by repeatedly subjecting the hydrogel to radiation or heat over several cycles, the toughness of the hydrogel can be further improved. This also avoids the problem of subjecting the hydrogel to high (and often undesirable) radiation or heat over long periods of time, which can degrade the hydrogel.

Accordingly, in some embodiments, the exposure step is performed 2 times while the cooling step is performed 1 time. In other embodiments, the exposure step is performed 3 times while the cooling step is performed 2 times. In other embodiments, the exposure step is performed 4 times while the cooling step is performed 3 times. In other embodiments, the exposure step is performed 5 times while the cooling step is performed 4 times. In other embodiments, the exposure step is performed 6 times while the cooling step is performed 5 times. In other embodiments, the exposure step is performed 7 times while the cooling step is performed 6 times. In other embodiments, the exposure step is performed 8 times while the cooling step is performed 7 times. In other embodiments, the exposure step is performed 9 times while the cooling step is performed 8 times. In other embodiments, the exposure step is performed 10 times while the cooling step is performed 9 times.

In some embodiments, the microwave radiation has a frequency of about 2 GHz to about 3 GHz. In other embodiments, the microwave has a power of 1000 W.

In some embodiments, the ion impregnated gel (from step (a)) is exposed to heat at a temperature of about 40° C. to about 100° C. In other embodiments, the temperature is about 50° C. to about 100° C., about 60° C. to about 100° C., about 70° C. to about 100° C., about 80° C. to about 100° C., or about 90° C. to about 100° C.

In some embodiments, the toughness of the hydrogel is increased by at least about 10 fold after the first exposure step (step (b)). In other embodiments, the toughness is increased by at least about 11 fold, about 12 fold, about 13 fold, about 14 fold, about 15 fold, about 16 fold, about 17 fold, about 18 fold, or about 20 fold.

By using the disclosed method, the hydrogel can be toughened within about 30 min. This is in contrast to the prior art method, which requires at least 24 h for ions to penetrate the hydrogel and which may not even reach homogenous end point.

FIG. 6 shows that the energy dissipation can be measured for a hydrogel that is exposed to different number of cycles of 15-second microwave exposure.

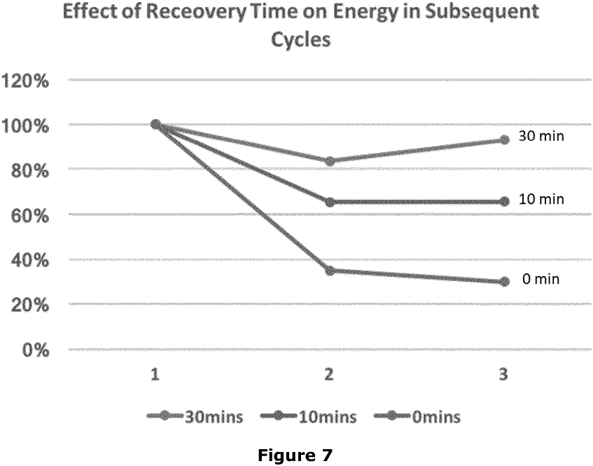

The hydrogels can also recover more of their mechanical strength after loading, as long as a sufficient recovery time is provided (FIG. 7).

FIG. 7 shows that, in general, the energy absorbable by the gels become lower with each loading cycle. However, with the right amount of resting time, the hydrogels can regain most of its mechanical strength, as a result of the reformation of broken inter-chain ionic crosslinks.

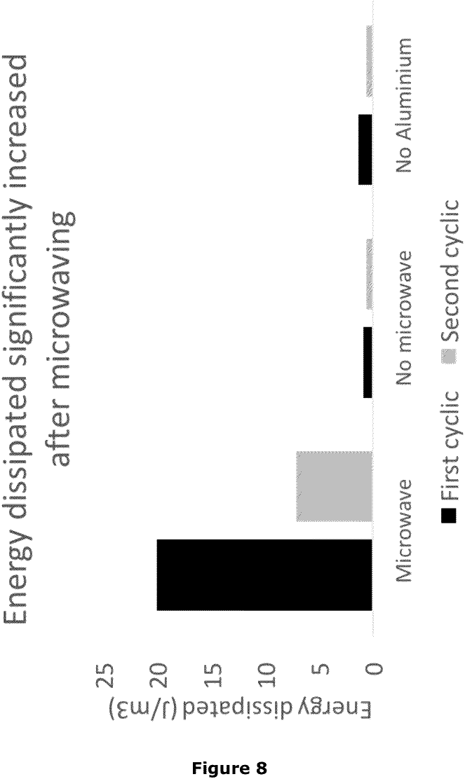

FIG. 8 compares an exemplary hydrogel of the present invention (microwave with Aluminium) with respect to a comparator (no aluminium). Without Aluminium, after microwaving, the energy dissipated is around 1 J/m³ (this is similar to energy dissipated for hydrogel without microwaving). With Al³⁺ and after microwaving, it is more than 16 J/m^{e}.

Microwaving is also able to increase stiffness of the samples. The increase in stiffness is about 2 times. Gels were definitely stiffer. It also appears that rapid heating can be more practical than sticking in oven, which also prevents drying out.

In some embodiments, the method of fabricating a tough hydrogel, comprises:
(a) polymerising a plurality of charged monomers in the presence of a plurality of multivalent ions under predetermined conditions in order to form an ion impregnated hydrogel;
(b) exposing the ion impregnated hydrogel to heat; and
(c) optionally repeating step (b) at least one further time in order to form the tough hydrogel;
wherein a valency of the multivalent ion is at least 3.

In some embodiments, the method of fabricating a tough hydrogel, comprises:
(a) polymerising a plurality of charged monomers in the presence of a plurality of multivalent ions under predetermined conditions in order to form an ion impregnated hydrogel;
(b) exposing the ion impregnated hydrogel to heat; and
(c) optionally repeating step (b) at least one further time in order to form the tough hydrogel;
wherein the multivalent ion is selected from Al³⁺, Fe³⁺ or a combination thereof.

In some embodiments, the method of fabricating a tough hydrogel, comprises:
(a) polymerising a plurality of charged monomers in the presence of a plurality of multivalent ions under predetermined conditions in order to form an ion impregnated hydrogel;
(b) exposing the ion impregnated hydrogel to heat; and
(c) optionally repeating step (b) at least one further time in order to form the tough hydrogel;
wherein the multivalent ion is selected from Al³⁺, Fe³⁺ or a combination thereof.

In some embodiments, the method of fabricating a tough hydrogel, comprises:
(a) polymerising a plurality of charged monomers in the presence of a plurality of multivalent ions under predetermined conditions in order to form an ion impregnated hydrogel;
(b) exposing the ion impregnated hydrogel to heat; and
(c) resting or cooling the ion impregnated hydrogel of step (b);
(d) repeating step (b) and/or step (c) at least one further time in order to form the tough hydrogel;
wherein the multivalent ion is at least 3.

In some embodiments, the method of fabricating a tough hydrogel, comprises:
(a) polymerising a plurality of charged monomers in the presence of a plurality of multivalent ions under predetermined conditions in order to form an ion impregnated hydrogel;
(b) exposing the ion impregnated hydrogel to heat; and
(c) resting or cooling the ion impregnated hydrogel of step (b);
(d) repeating step (b) and/or step (c) at least one further time in order to form the tough hydrogel;
wherein the multivalent ion is selected from Al³⁺, Fe³⁺ or a combination thereof.

The present invention also provides a hydrogel as fabricated by the method as disclosed herein.

Using these materials, the ability to form a tough gel using a photocrosslinked hydrogel can be demonstrated. As a gel is loaded (e.g. by stretching), the external force does work on it. However, the amount of elastic energy recovered on unloading is smaller than the work done on it initially. The different paths taken along the loading and unloading phases is known as the hysteresis loop, and the area bounded by the loop represents the energy absorbed by the hydrogel, as a result of inter-chain ionic bond breakage. Since the ionic bonds take time to re-form after unloading, the second cyclic loading (if performed immediately after the first cycle) typically shows a smaller hysteresis loop.

The present invention also provides a hydrogel, comprising:
(a) a plurality of charged polymers, the plurality of charged polymers is covalently crosslinked and comprises at least a charged moiety; and
(b) a plurality of multivalent ions in order to form ionic crosslinks between the plurality of charged polymers;
wherein a valency of the plurality of multivalent ions is at least 2.

In some embodiments, the hydrogel comprises:
(a) a plurality of charged polymers, the plurality of charged polymers is covalently crosslinked and comprises a plurality of charged moiety; and
(b) a plurality of multivalent ions in order to form ionic crosslinks between the plurality of charged polymers;
wherein a valency of the plurality of multivalent ions is at least 2.

The plurality of charged polymers is formed from the plurality of charged monomers. Accordingly, the plurality of charged polymers comprises a plurality of polymerised charged monomer units.

In some embodiments, the plurality of charged polymers is a salt form of a plurality of polymers, the polymers selected from polyacrylic acid, polyacrylamide, polysulfopropyl acrylate, poly(2-hydroxyethyl) methacrylate or a combination thereof.

In some embodiments, the plurality of multivalent ions in the hydrogel has a concentration of about 1 × 10²¹ ions per L to about 1 × 10²⁴ ions per L. In other embodiments, the concentration is about 1 x 10²¹ ions per L to about 9 x 10²³ ions per L, about 2 x 10²¹ ions per L to about 9 x 10²³ ions per L, about 3 x 10²¹ ions per L to about 9 x 10²³ ions per L, about 4 x 10²¹ ions per L to about 9 x 10²³ ions per L, about 5 x 10²¹ ions per L to about 9 x 10²³ ions per L, about 6 x 10²¹ ions per L to about 9 x 10²³ ions per L, about 6 x 10²¹ ions per L to about 8 x 10²³ ions per L, about 6 x 10²¹ ions per L to about 7 x 10²³ ions per L, about 6 x 10²¹ ions per L to about 6 x 10²³ ions per L, about 6 x 10²¹ ions per L to about 5 x 10²³ ions per L, about 6 x 10²¹ ions per L to about 4 x 10²³ ions per L, or about 6 x 10²¹ ions per L to about 3 x 10²³ ions per L.

In some embodiments, the hydrogel has a at least 80% recovery of mechanical strength after a resting period of about 30 min. In other embodiments, the recovery is about 85%, or about 90%. In other embodiments, the hydrogel has a recovery of mechanical strength of more than about 80% after a resting period of about 30 min.

In some embodiments, the hydrogel has a at least 60% recovery of mechanical strength after a resting period of about 10 min. In other embodiments, the recovery is about 65%, or about 70%. In other embodiments, the hydrogel has a recovery of mechanical strength of more than about 60% after a resting period of about 30 min.

In some embodiments, the hydrogel has a thickness of about 1 mm to about 100 cm. In other embodiments, the thickness is about 1 cm to about 100 cm, about 2 cm to about 100 cm, about 3 cm to about 100 cm, about 5 cm to about 100 cm, about 10 cm to about 100 cm, about 20 cm to about 100 cm, about 30 cm to about 100 cm, about 40 cm to about 100 cm, or about 50 cm to about 100 cm. In other embodiments, the thickness is about 1 cm to about 10 cm.

In some embodiments, the toughness of the hydrogel is increased by at least about 5%. The increase in toughness is taken relative to the hydrogel before the exposure to heat. In other embodiments, the toughness is increased by at least about 10%, at least about 20%, at least about 30%, at least about 40%, at least about 50%, at least about 60%, at least about 70%, at least about 80%, at least about 90%, at least about 100%, at least about 200%, at least about 300%, at least about 400%, at least about 500%, at least about 600%, at least about 700%, at least about 800%, at least about 900%, or at least about 1000%.

In some embodiments, the toughness of the hydrogel is at least about 5 J/m³.

In other embodiments, the toughness is at least about 6 J/m³, about 8 J/m³, about 10 J/m³, about 12 J/m³, about 14 J/m³, about 16 J/m³, about 18 J/m³, about 20 J/m³. In other embodiments, the toughness is about 5 J/m³ to about 100 J/m³, about 5 J/m³ to about 90 J/m³, about 5 J/m³ to about 80 J/m³, about 5 J/m³ to about 70 J/m³, about 5 J/m³ to about 60 J/m³, about 5 J/m³ to about 50 J/m³, about 5 J/m³ to about 40 J/m³, about 5 J/m³ to about 30 J/m³, or about 5 J/m³ to about 20 J/m³.

The stiffness of the hydrogel can also be varied. In some embodiments, the hydrogel has a Young’s modulus of about 5 kPa to about 30 kPa. In other embodiments, the hydrogel has a Young’s modulus of about 10 kPa to about 30 kPa, about 15 kPa to about 30 kPa, or about 20 kPa to about 30 kPa. Preferably, the Young’s modulus is of more than about 14 kPa to about 30 kPa. The stiffness of the hydrogel can be described by the Young’s modulus (elastic modulus).

In some embodiments, the hydrogel can have a strain of at least 500%.

In some embodiments, the hydrogel comprises:
(a) a plurality of charged polymers, the plurality of charged polymers is covalently crosslinked and comprises at least a charged moiety; and
(b) a plurality of multivalent ions impregnated within the hydrogel in order to form ionic crosslinks between the plurality of charged polymers;
wherein a valency of the plurality of multivalent ions is at least 3.

In some embodiments, the hydrogel comprises:
(a) a plurality of charged polymers, the plurality of charged polymers is covalently crosslinked and comprises at least a charged moiety; and
(b) a plurality of multivalent ions impregnated within the hydrogel in order to form ionic crosslinks between the plurality of charged polymers;
wherein the multivalent ion is selected from Al³⁺, Fe³⁺ or a combination thereof.

In some embodiments, the hydrogel comprises:
(a) a plurality of charged polymers, the plurality of charged polymers is covalently crosslinked and comprises at least a charged moiety; and
(b) a plurality of multivalent ions impregnated within the hydrogel in order to form ionic crosslinks between the plurality of charged polymers;
wherein the multivalent ion is selected from Al³⁺, Fe³⁺ or a combination thereof;
wherein the toughness of the hydrogel is at least about 5 J/m³.

In some embodiments, the hydrogel comprises:
(a) a plurality of charged polymers, the plurality of charged polymers is covalently crosslinked and comprises at least a charged moiety; and
(b) a plurality of multivalent ions impregnated within the hydrogel in order to form ionic crosslinks between the plurality of charged polymers;
wherein the multivalent ion is selected from Al³⁺, Fe³⁺ or a combination thereof;
wherein the toughness of the hydrogel is at least about 5 J/m³;
wherein the hydrogel has a at least 80% recovery of mechanical strength after a resting period of about 30 min.

The present method thus allows for rapid 3D printing of complex structures using the covalent hydrogel network, that can then be quickly heated and cooled to achieve excellent toughness. Such are applicable in wound healing applications and organ replacements. The hydrogel can also be used as a material at the skin electrode interface and as surgical phantoms.

### EXAMPLES

### Comparator 1

Gels were formed using 20 wt% acrylic acid, 0.05 wt% bis-acrylamide, 1 mM LAP photoinitiator. The gel was not heated. The toughness was around 1 J/m³.

### Comparator 2

Gels were formed using 20 wt% acrylic acid, 0.05 wt% bis-acrylamide, 1 mM LAP photoinitiator, and 100 mM AICI₃. The gel was not heated. The toughness was around 1 J/m³. The Young’s modulus ranged from 6.5 kPa to 8 kPa. The strain rate is about 10 mm/min. For most materials, the mechanical properties will change depending on the strain rate. It represents how quickly the gel is stretched.

### Comparator 3

100 mM Al³⁺ was pre-mixed with gels and subjected to incubation at 37° C. overnight. The toughness was around 1 J/m³. The Young’s modulus was about 12 kPa.

### Example 1

100 mM AICI₃ was pre-mixed with gels and subjected to microwave treatment for 10 sec. The gel was microwave treated by immersing the gel in a water bath and microwaved. The temperature of the water bath reached at least 70° C. The toughness was around 16 J/m³. The Young’s modulus ranged from 6.9 kPa to 14 kPa. The strain rate is about 10 mm/min.

### Example 2

100 mM AICI₃ was pre-mixed with gels and subjected to microwave treatment for 55 sec, 30 sec pause, microwave treatment for 15 sec, 30 sec pause, microwave treatment for 5 sec. The microwave treatment was performed by soaking in a water bath (water volume is about 50 mL) and allowing the gel to sit in the water bath during the pause step. The gel was immersed in the water bath for at least another 2 min after the microwave treatment. The toughness was around 16 J/m³. The Young’s modulus ranged from about 18 kPa to 20 kPa. The strain rate is about 10 mm/min.

### Example 3: General Protocol for Fabricating Hydrogel From Monomers

A trivalent cation was introduced into the acrylic acid monomer (20 wt% acrylic acid), lithium phenyl-2,4,6-trimethylbenzoylphosphinate (LAP; 1 mM) photoinitiator and bis-acrylamide (0.05 wt%) before polymerization. For example, aluminium (Al³⁺) can be used. Photocrosslinking the gel rapidly creates a soft, stretchy hydrogel. However, since the monomers associated with the Al³⁺ are likely to be incorporated into a single chain (due purely to proximity), they will not dissipate significant amounts of energy when loaded. Next, the gel is subject to heating by microwave. This process allows the ionic interactions to be disrupted/re-arranged. The power is about 1000 W, and an exemplary microwave cycle can be 7 sec of heating followed by 30 sec pause. The cycle was repeated from 1 up to 10 times in various trials. This cycling protocol is to prevent overheating and gas expansion, which will cause the gel to rupture. On cooling, the ionic bonds re-form randomly, permitting the formation of inter-chain ionic crosslinks. The exposure to microwave radiation and/or heat can be repeated a few times to further increase the toughness of the hydrogel. This hydrogel is tougher than the comparator examples. The gels prepared can reach about 15-20 J/m³.

It will be appreciated that many further modifications and permutations of various aspects of the described embodiments are possible. Accordingly, the described aspects are intended to embrace all such alterations, modifications, and variations that fall within the spirit and scope of the appended claims.

Throughout this specification and the claims which follow, unless the context requires otherwise, the word “comprise”, and variations such as “comprises” and “comprising”, will be understood to imply the inclusion of a stated integer or step or group of integers or steps but not the exclusion of any other integer or step or group of integers or steps.

The reference in this specification to any prior publication (or information derived from it), or to any matter which is known, is not, and should not be taken as an acknowledgment or admission or any form of suggestion that that prior publication (or information derived from it) or known matter forms part of the common general knowledge in the field of endeavour to which this specification relates.

1. A method of fabricating a tough hydrogel, comprising:
(a) polymerising a plurality of charged monomers in the presence of a plurality of multivalent ions under predetermined conditions in order to form an ion impregnated hydrogel;
(b) exposing the ion impregnated hydrogel to heat;
(c) cooling the ion impregnated hydrogel of step (b); and
(d) optionally repeating step (b) and/or step (c) at least one further time in order to form the tough hydrogel,
wherein a valency of the multivalent ion is at least 2.

2. The method according to claim 1, wherein the plurality of charged monomers is a charged vinyl monomer.

3. The method according to claim 1, wherein the plurality of charged monomers is a salt form of a plurality of monomer, the monomer is selected from acrylic acid, acrylamide, sulfopropyl acrylate, 2-hydroxyethyl methacrylate or a combination thereof.

4. The method according to of claim 1, wherein the plurality of charged monomer is provided at a concentration of about 5 wt% to about 50 wt%.

5. The method according to claim 1, wherein the step of polymerising (step (a)) further comprises a cross linking agent.

6. The method according to claim 5, wherein the cross linking agent is N,N′-methylenebisacrylamide.

7. The method according to claim 1, wherein the plurality of multivalent ions is a plurality of multivalent cations.

8. The method according to claim 1, wherein the plurality of multivalent ions is selected from Al³⁺ and Fe³⁺.

9. The method according to claim 1, wherein the plurality of multivalent ions is provided at a concentration of about 10 mM to about 2 M.

10. The method according to claim 1, wherein the step of exposing (step (b)) crosslinks the ion impregnated hydrogel (from step (a)) via ionic interactions.

11. The method according to claim 1, wherein the ion impregnated hydrogel (from step (a)) is exposed to heat at a temperature of about 40° C. to about 100° C.

12. The method according to claim 1, wherein the ion impregnated hydrogel (from step (a)) is heated by exposing the ion impregnated hydrogel or to microwave radiation for at least 15 sec.

13. The method according to claim 1, when step (b) and/or step (c) is repeated 2 to 10 times.

14. The method according to claim 1, wherein the cooling step is performed for at least about 10 sec.

15. The method according to claim 1, wherein the toughness of the hydrogel is increased by at least about 100%.

16. A hydrogel as fabricated by the method according to claim 1.

17. A hydrogel, comprising:
(a) a plurality of charged polymers, the plurality of charged polymers is covalently crosslinked and comprises a plurality of charged moiety; and
(b) a plurality of multivalent ions in order to form ionic crosslinks between the plurality of polymers,
wherein a valency of the plurality of multivalent ions is at least 2.

18. The hydrogel according to claim 17, wherein the plurality of charged polymers is a salt form of a plurality of polymers, the polymers selected from polyacrylic acid, polyacrylamide, polysulfopropyl acrylate, poly(2-hydroxyethyl) methacrylate or a combination thereof.

19. The hydrogel according to claim 17, the hydrogel having a at least 80% recovery of mechanical strength after a resting period of about 30 min.
